(19) United States
(12) Patent Application Publication
(10) Pub. No.: US 2005/0071485 A1
(43) Pub. Date: Mar. 31, 2005

(54) System and method for identifying a network resource

(76) Inventor: Arun Ramagopal, Sherman Oaks, CA (US)

Correspondence Address: MICHAEL J. BUCHENHORNER, ESQ;HOLLAND & KNIGHT, 701 BRICKELL AVENUE, MIAMI, FL, 33131, US

(21) Appl. No.: 10/672,910

(22) Filed: Sep. 26, 2003

(51) Int. Cl. G06F 15/16

(52) U.S. Cl. 709/230

(57) ABSTRACT

In an information handling system for identifying resources comprising packets of data received from a network, a method comprises steps of receiving resources comprising one or more packets, each packet comprising a header and data; scanning the header and data of the one or more packets to extract identifying information relating to the resource; comparing the extracted information to a list of identifying information in a database and providing a message indicating that the extracted information matches at least one entry in the database when the comparison is positive.

### CROSS-REFERENCE TO RELATED APPLICATIONS

Not Applicable.

### STATEMENT REGARDING FEDERALLY SPONSORED-RESEARCH OR DEVELOPMENT

Not Applicable.

### INCORPORATION BY REFERENCE OF MATERIAL SUBMITTED ON A COMPACT DISC

Not Applicable.

### FIELD OF THE INVENTION

The invention disclosed broadly relates to the field of information technologies and more particularly relates to the field of firewalls and transmission of network resources.

### BACKGROUND OF THE INVENTION

HTTP is the most common protocol in use for web browsing and file downloads. It is a TCP-based protocol and thus data packets are sent and received in an orderly manner by both the client and server. Data packets using this protocol comprise two parts: header information and data. An HTTP proxy server is a common network node that decodes the HTTP protocol, and is currently one of several network gateway devices used by network administrators to limit access by nodes in an intranet or local area network (LAN) to the Internet. For example, pornography sites, email sites such as Hotmail, and sports sites are commonly blocked at corporation network gateway devices. This is generally done through an HTTP proxy server installed at the LAN, by eliminating certain IP addresses from the LAN's local DNS server, or by adding IP-based restrictions at any other node. These network gateway devices scan the incoming request for the destination domain name or IP address. If the field matches a set of known Internet locations (IP addresses or domain names) then the request is blocked. The set of Internet locations is normally maintained by hand by the network administrators who installed the network gateway device. However, blocking unwanted resources from the Internet is a challenging task. Much of this difficulty is due to the fact that the information needing to be scanned can be a combination of the header and data part of the packet, packets are considered stateless, and the specific data sections (offsets) to scan are constantly changing due to new and evolving Internet-enabled programs and DNS entries.

### SUMMARY OF THE INVENTION

Briefly according to the invention, a method comprises steps of routing network communication comprising one or more packets, each packet comprising bytes structured according to the Internet Protocol (IP); gathering and storing unordered packets in memory in order to effectively scan UDP-based protocols; scanning the bytes of one or more packets to extract identifying information relating to the network resource; comparing the extracted identifying information to a set of identifying information stored in a database; using a central server farm that constantly finds the identifying information to be filtered and updates each database; and providing a message indicating that the extracted information matches at least one entry in the database when the comparison is positive.

### BRIEF DESCRIPTION OF THE DRAWINGS

FIG. 1 is an illustration of a network comprising a system according to the present invention.

FIGS. 2-4 show various configuration of local area networking using the invention.

FIG. 5 is a high level flow chart illustrating a method according to the invention.

FIG. 6 illustrates a system for identifying network resources.

FIGS. 7a-7b show a flowchart illustrating a detailed method according to an embodiment of the invention.

FIG. 8 shows an HTTP GET Method request where structure information is only in the header section.

FIG. 9 shows an HTTP POST Method request structure where information is in both the header and data sections.

FIG. 10 shows the response from a server to an HTTP request.

FIG. 11 shows a Peer to Peer request using Fasttrack communication and a hash code.

FIG. 12 shows a Peer to Peer request using Fasttrack communication and a filename.

FIG. 13 shows the response from a server using Fasttrack communication to a Peer to Peer request.

FIG. 14 shows a Peer to Peer request using Gnutella communication and a filename.

FIG. 15 shows a response from a server to a Peer to Peer request using Gnutella communication.

FIG. 16 shows a retrieved resource using a File Transfer Protocol.

### DETAILED DESCRIPTION

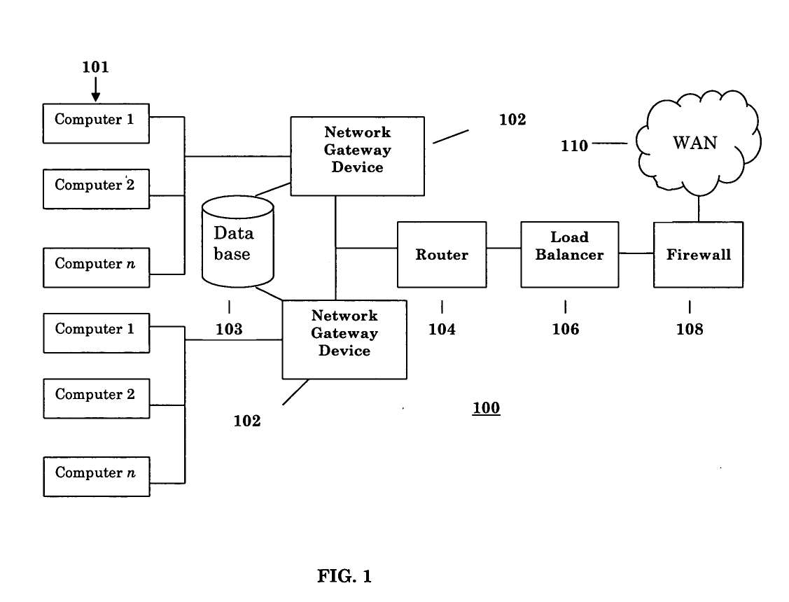

Referring to FIG. 1, there is shown a block diagram of a local area network 100 comprising network gateway devices (NGD) 102 according to an embodiment of the invention. In the embodiment shown in FIG. 1, the LAN 100 comprises a plurality of NGDs 102 (represented by the two shown), each serving a set of client personal computer units 101. The NGDs 102 protect their clients 101 from access to undesired resources by routing packets either received from the WAN 110 or from clients 101 and comparing identifying information such as metadata about network resources in the packets with identifying information stored in a database 103. The database 103 is shown as a shared resource but the network 100 can also be implemented with a database 103 embedded in each NGD 102 so that it can be accessed directly through its API. In any case each database is regularly updated. When the comparison is positive (i.e., a match is found), the NGD 102 provides a message indicating the match. The message can either be displayed as a warning that the content may be inappropriate or misappropriated or to trigger one of various ways of filtering (filtering includes tracking and blocking) the access.

“Identifying information” is information found in the received stream of packets that is useful for deciding whether to provide access to the network resource. The database 103 is updated to include identifying information relating to resources to which access by clients is to be controlled. The database 103 can be either shared as shown in FIG. 1 or can be integrated into each of the NGDs 102. In either case, a communication process is in place to update the identifying information for all databases in the system such that the databases operate in a real time manner. The identifying information can be any information that can be extracted or derived from the packets, being transferred throughout the networks 100 and 110 that can be used to identify a resource comprising one or more of the packets.

In a preferred embodiment, the set of metadata changes for the application being used. The first scanning step of NGD102 is to determine the application being used by the client. In its current embodiment, applications supported are as follows: 1) Web browsers, 2) the Peer 2 Peer programs based on the Fasttrack and Gnutella protocols, specifically Kazaa, Morpheus, Grokster, and their clones, 3) FTP programs, and 4) specialized SMTP junkmail programs such as WorldCast that allow users to run a local SMTP server and bypass their ISP's SMTP server.

For Web browsers, there are two scanning algorithms that take place along with two sets of metadata. The first scanning algorithm bases its decision on the following metadata obtained from the data packet stream and contained in the database 103: 1) IP address, 2) port, 3) path, 4) resource or file name. As an example, in the following theoretical scenario an HTTP client sends the following request:
1 GET/illegalfiles/IllegalResource.zip HTTP/1.0
2 HOST: www.illegalhost.com
3 [BLANK_LINE][END_OF_STREAM]

The NGD 102 understands the HTTP application-level protocol, and thus extracts the following information: 1) the IP address based on NGD 102's DNS lookup of the domain name, or directly if the IP address is contained in the client's request, 2) if the port is not contained in the request, the default HTTP port, 80, is used, 3) the path contained in Line 1 above, and 4) the resource as identified by Line 1 above. Since illegalhost.com is an example, 127.0.0.1 will be the theoretical IP address found after domain name resolution. Thus, the extracted information is as follows: 1) 127.0.0.1, 2) 80, 3) illegalfiles, 4) IllegalResource.zip. In this embodiment, this is all the information needed by NGD 102 to effectively block very specific network resources for this HTTP request method.

If it is determined by the NGD 102 that further scanning is needed because the resource contains an HTML form or processing is needed for the query string, then additional metadata is extracted and examined from the same data packet stream. This additional metadata is as follows: 5) HTML form name-value pairs. In its current embodiment, this information is stored in the same table as described above in the Database with column 5 optional. As an example, in the following scenario the HTTP client sends the following request:
1 POST/forms/webform.html HTTP/1.0
2 HOST: www.illegalhost.com
3 [BLANK_LINE]
4 resource=IllegalResource.zip&user=username
5 [BLANK_LINE][END_OF_STREAM]

The HTTP post method sends an unlimited amount of HTML form data after the blank line so that it is considered the data portion of HTTP communication and does not have any size restrictions. This allows HTML forms to contain fields that are very large. In contrast, if a webpage contains an HTML form that contains small fields, it is very common to use the GET method. The following HTTP request has the same purpose as above, but uses the GET method and embeds the form values in the Query String:
1 GET /forms/webform.html?resource=IllegalResource.zip&user=username HTTP/1.0
2 HOST: www.illegalhost.com
3 [BLANK_LINE]][END_OF_STREAM]
   In these two scenarios, the form values can be used to request a resource and must be understood by NGD 102 in order to effectively block the transmission. Thus, the following information is extracted: 1) 127.0.0.1, 2) 80, 3) forms, 4) webform.html, 5) resource=IllegalResource.zip. It ignores the username of the form since in this theoretical case the CSF (central server farm) has decided this field is not necessary for NGD 102 to determine the resource. If this information is found in the Database, the network resource transmission is ended.

The LAN 100 supports a packet-switched protocol and is connected to a wide area network 110 (such as the Internet) by means of a conventional firewall 108. The LAN 100 can also comprise a conventional load balancer 106 disposed between the NGDs 102 and the firewall 108 and a conventional router 104 disposed between the load balancer and the NGDs 102.

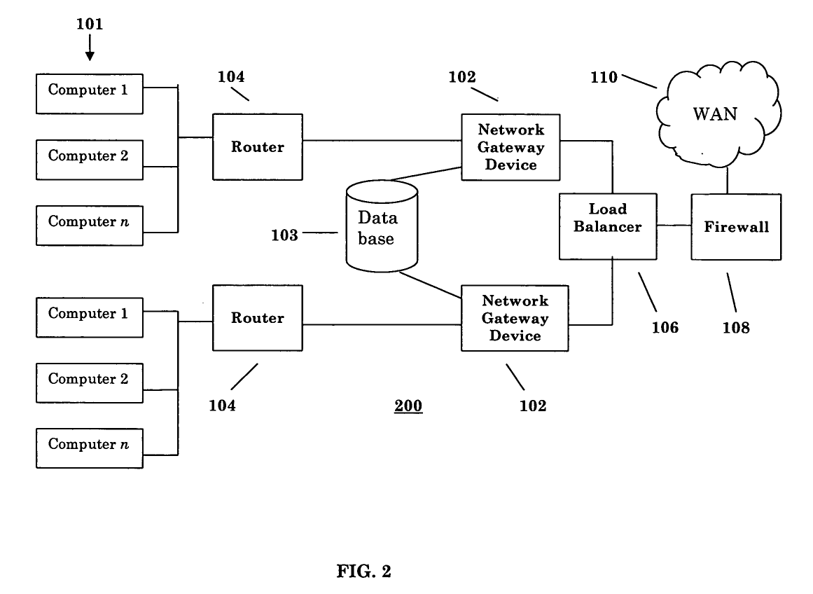

FIG. 2 illustrates an embodiment of the invention wherein the NGDs 102 are each connected to the firewall 108 by means of the load balancer 106.

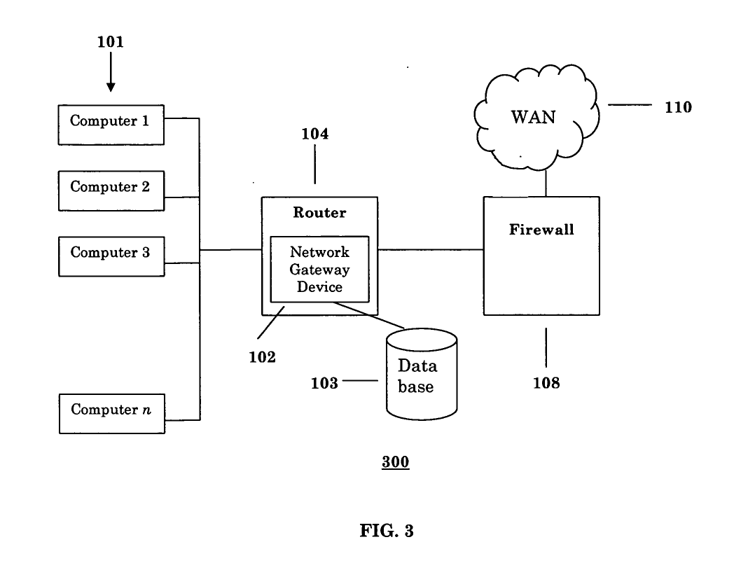

FIG. 3 illustrates an embodiment of the invention wherein the router 104 includes an NGD 102 and the router is disposed between the firewall 108 and the client computers 101.

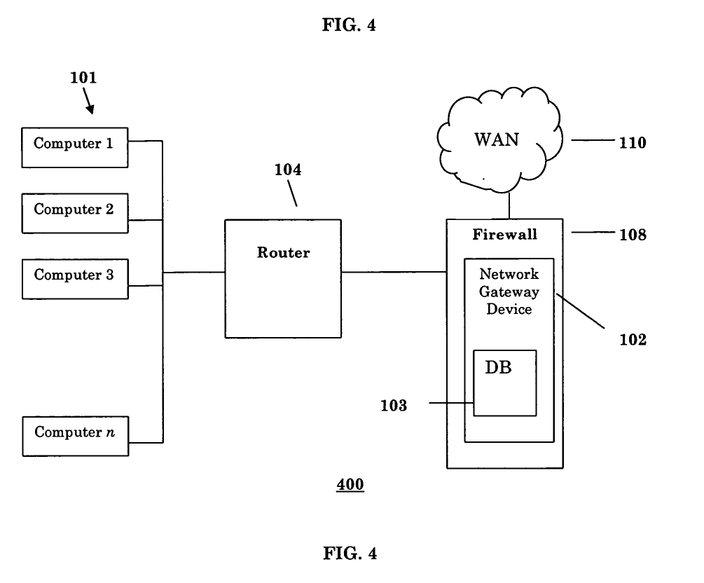

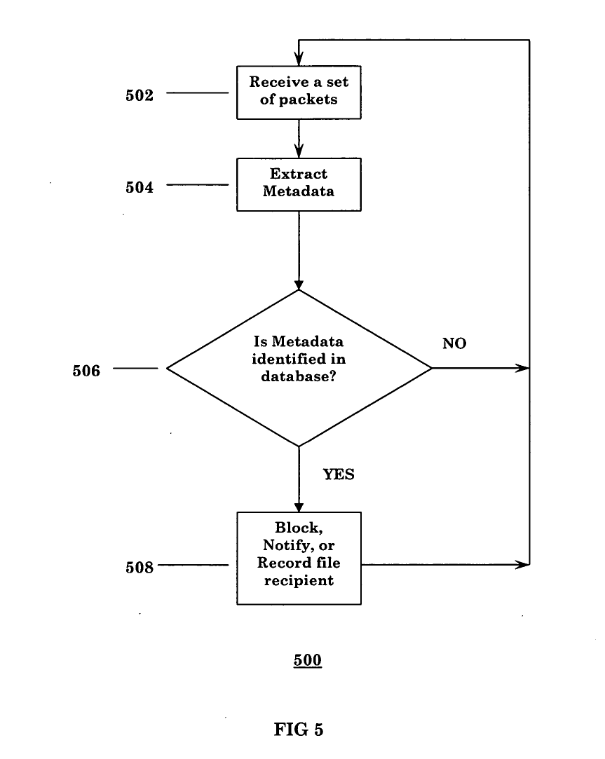

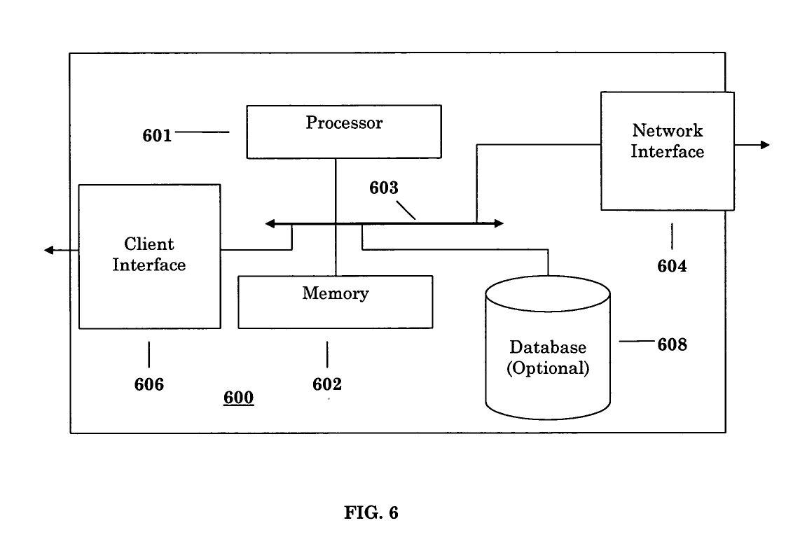

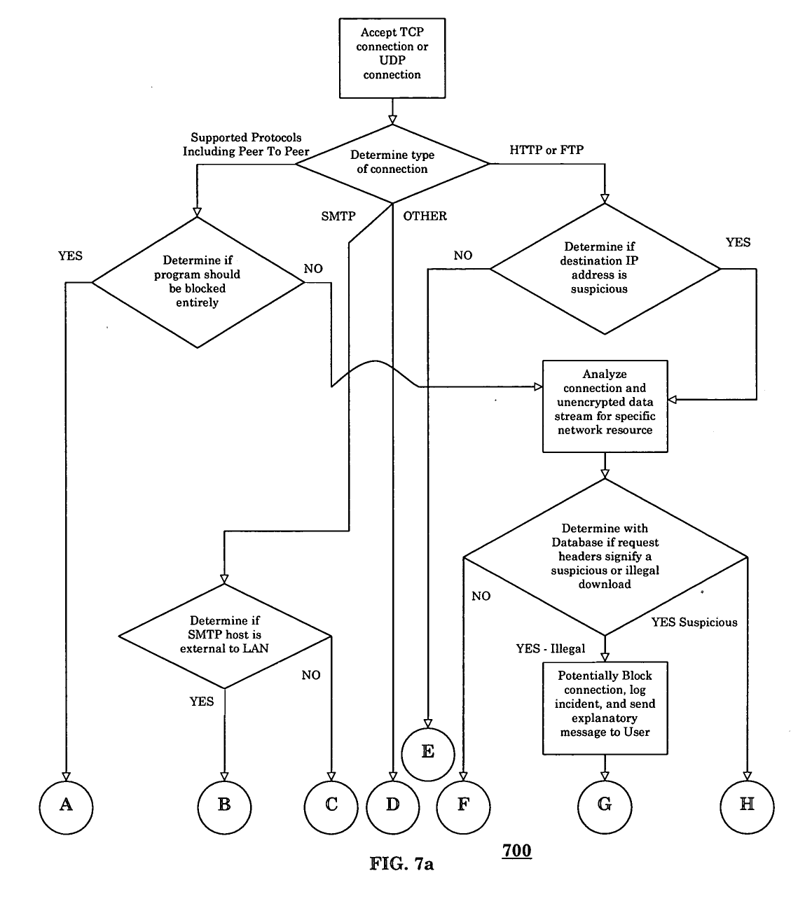

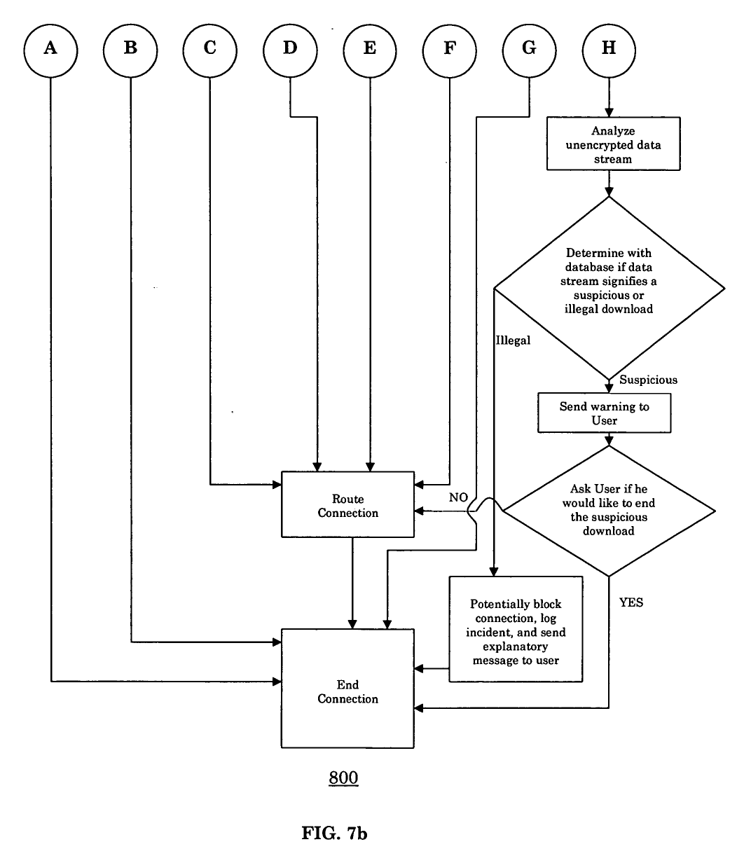

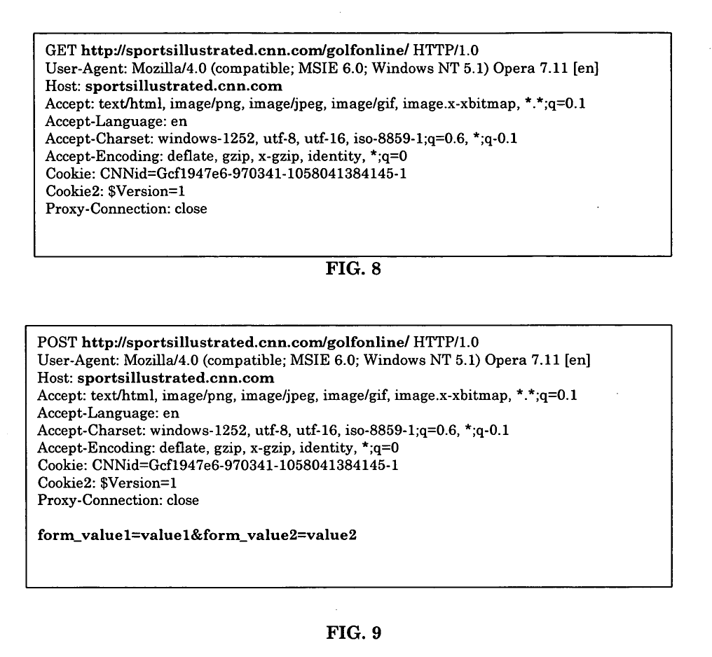

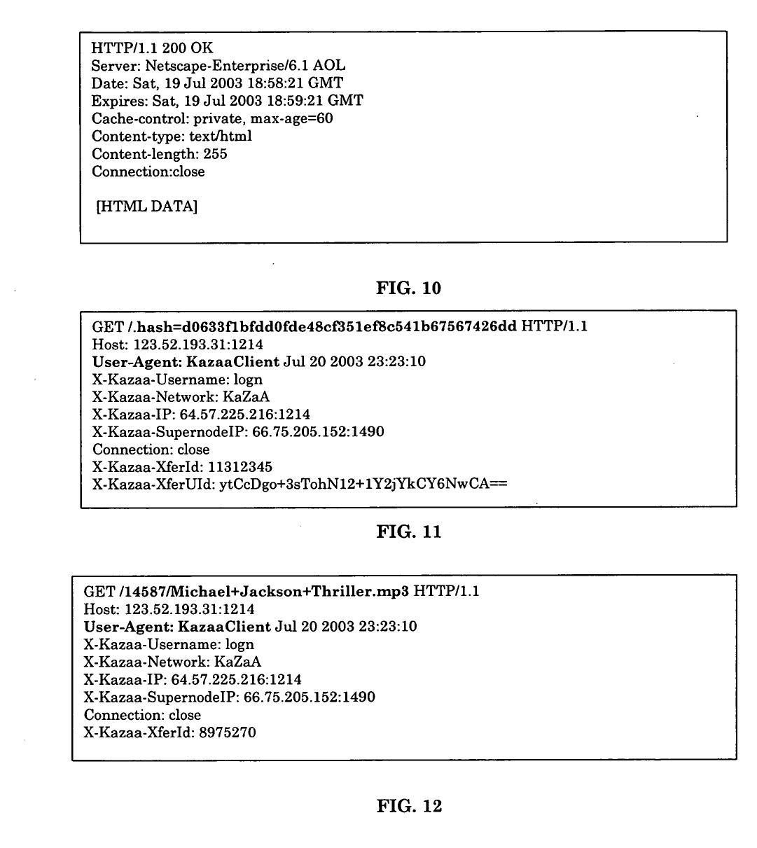

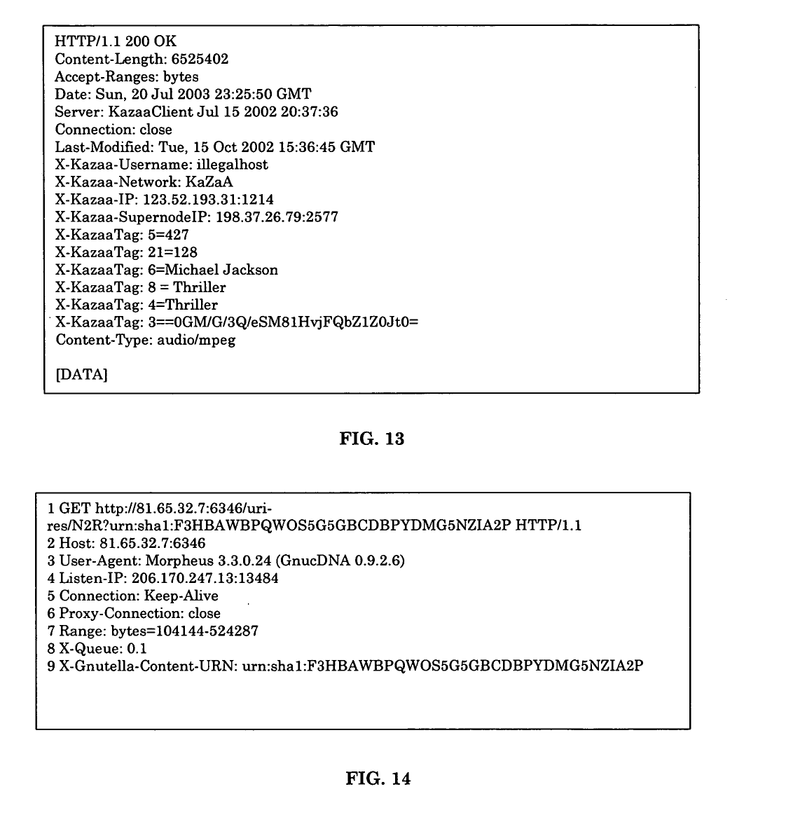

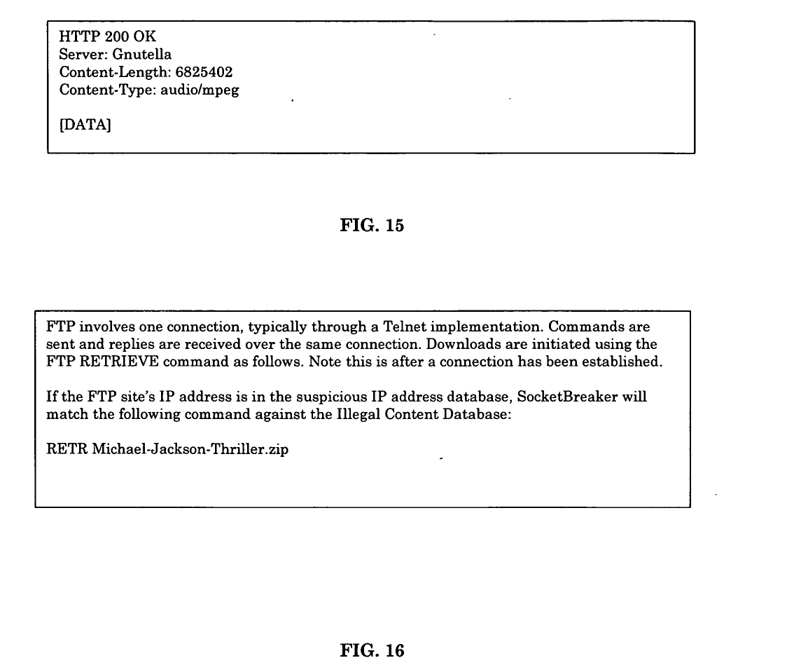

FIG. 4 illustrates an embodiment of the invention wherein the firewall 108 comprises an NGD 102.

The network gateway device is preferably an open standard generic application proxy server that combines firewall technologies and application-level resource filtering techniques. It preferably complies with the most common proxy server standards used, such as SOCKS versions 4 and 5. It is preferably implemented with the fastest and most reliable cross-platform programming language available, such as Java 1.4.2. The NGD 102 can be used to do any of the following:

The NGD 102 can warn users that it appears they are downloading illegal material. This is a service that ISPs and schools can provide to their users.

The NGD 102 can block specific network resources such as application, music, or movie files that appear to be pirated versions of the material. It is at the network manager's discretion to allow full blocking or to allow illegal downloads to continue with the warning described above. The NGD 102 supports both types of behavior, although blocking is the preferred solution.

The NGD 102 can block specific programs based on their application-level protocols from being transmitted within that LAN. These protocols can use either TCP (Transmission Control Protocol) or UDP (User Datagram Protocol). For instance, if an ISP (Internet Service Provider) decides that the Kazaa program should not be run on the LAN, the NGD 102 can be configured to support this behavior.

The NGD 102 can also limit access to external SMTP hosts by only allowing users to make direct TCP connections to specified SMTP servers that the LAN can monitor. This prevents users from sending junk emails from that LAN.

The NGD 102 can also prevent external users from downloading illegal material from users within the LAN.

The NGD 102 provides generic support for any IP-based application-level protocol which uses TCP or UDP. In its current embodiment, this is done by conforming to the SOCKS protocol and providing application-level resource-filtering algorithms when necessary. The application-level protocols supported are taken from current versions of TCP-based and UDP-based applications, such as Peer2Peer, HTTP, FTP, and IRC programs. The NGD 102 preferably uses the data that is sent with these programs to analyze the network communication between any client and server. Based on this stream of data packets, The NGD 102 can stop the communication at any point or warn users of activity not supported by their LAN.

A core feature of the NGD 102 is the implementation of a self-updating and real time database. Each database 103 table maps directly to metadata used by application-level protocols in order for NGD 102 to block specific network resources that these protocols are being used to request. There are tables for the HTTP, FTP, Fasttrack, and Gnutella protocols. In its preferred embodiment, NGD 102 does not use the database 103 for limiting access to SMTP hosts, but instead uses a configuration setting.

The tables in the current embodiment of the database 103 contain the following columns:
HTTP: “IP address”, “port”, “path”, “resource name”, “priority”
FTP: “IP address”,“path”,“resource name”, “priority”
Fasttrack: “Fasttrack Hash Code”, “priority”
Gnutella: “SHA1 Hash Code”, “priority”
P2P-Alternate: “IP address”, “port”, “identity-key”, “resource name”, “priority”

In its preferred embodiment, the Database 103 synchronizes its data with the Central Server Farm in a near real-time manner by listening on a specified port. Whenever a Database 103 starts, even if embedded within an NGD 102, it contacts the CSF and registers its currently configured IP address and port. Thus, the CSF uses its list of Database 103s to send a message signifying either a new entry in or a removal from the Database 103. Database 103s may also request a full synchronization or update at any time by contacting the CSF. In a default installation of the preferred embodiment, a full synchronization happens daily at 12 AM in order to maintain each Database 103's data integrity. This allows for the following unique benefits: (1) The protected material is always current. (2) Wrongfully blocked material can be removed in a near real-time fashion. (3) A daily log from each NGD is sent to a data warehouse containing only the metadata which caused a blocked request. This data contains the same information in the Database tables described above, and is used only to determine the NGD's effectiveness. For instance, in the case of a Fasttrack network resource transmission block, the following information is logged: “Fasttrack Hash Code”.

The NGD 102 will actively filter against the following five protocols:
1) HTTP;
2) FTP;
3) SMTP;
4) Fasttrack; and
5) Gnutella
   However, the NGD 102 can easily be adapted to prevent or warn of access to resources in network modes using different protocols.

The NGD 102 is preferably a SOCKS versions 4 and 5 implementation as described above that also understands the hypertext transfer protocol and other common application-level protocols. Because of this combination of technologies and its unique scanning algorithms, the NGD 102 supports the following additional services that a traditional HTTP proxy server does not:
1) Scanning additional header fields besides the host field;
2) Identifying and scanning additional protocols that use nonstandard HTTP headers known as HTTP extensions;
3) Scanning the data portion of HTTP communication, that is, the bytes occurring after the first blank line as per the HTTP specification;
4) Using the information contained in the database in order to filter requests. This database is self-updating, and thus does not allow tampering or the involvement of a network administrator.

The NGD 102 can also interpret HTTP form data based on the specific webpage where the form exists.

### FTP

FTP is one of the oldest TCP protocols. A client uses one connection in order to maintain a session with a server. This communication is also analyzed by NGD 102. Many hackers use public FTP sites to host illegal files for a short period of time. These sites are known as 0-day sites, and are referred to as such because on the 1^{st} day an accessible site is discovered (day 0) its utility rating is 100%. The owner of the site does not yet know it is being used for illegal purposes, and not many users know the IP address. By day 10, the usefulness of the site is said to be at 1/1000^{th} of the utility level of day 0. At this point, many users have discovered the IP address and the site's owner may be notified of the security breach. When this happens, the hackers remove the IP address from their lists.

Hackers are in constant search of public web or FTP sites in which to store their files. Many of these servers are in other countries and thus are impossible to shut down by United States laws. Yahoo! Groups (™) is another common public storage facility for hackers. Specific groups are created simply to distribute files.

Because of the near real-time Database 103, a system using the invention can actively protect against 0-day web and FTP sites. Only specific file requests are blocked, and so public access to the FTP site is never restricted by the NGD 102. Similarly, Yahoo! Groups and similar web sites are not blocked as a whole, but rather only specific files stored on these sites are.

### Fasttrack and Gnutella Peer2Peer Protocols

Both Fasttrack and Gnutella use an extended version of HTTP as the primary transport protocol for downloads. This provides reliability and stability for large file downloads. Although UDP and HTTPS are used for communication with and discovery of peers on the network, all programs currently use HTTP as the download protocol.

This fact allows NGD 102 to block or warn against downloads by matching the file signatures found in the request against the Database 103. HTTP is not encrypted and thus NGD 102 is free to analyze any portion of the network communication.

The notion of a hash code is very important to all Fasttrack and Gnutella clients. Fasttrack defines the “Fasttrack Hash Code”, while Gnutella has the “SHA1.” The use of hash codes is an evolution of previous Peer 2 Peer protocols, and allows a client to easily identify any file among hundreds of millions, or billions, of files. It is analogous to a fingerprint in that each hash code is a unique file signature. Several websites exist to catalog hash codes. These files have been verified to be the real working version, and not a decoy or corrupted file. These are the three most popular websites that perform this service:
http://www.verifieddownloads.com/
http://www.fasttrackmovies.com/
http://www.fasttrackcentral.com/

In addition to providing a unique identity, hash codes allows for one client to download from an arbitrary number of servers. With a broadband connection, a user can typically download the same file from 16 different users at the same time. The client then puts the file back together. This ability is incredibly powerful and, at the current time, is only possible due to hash codes.

The blocking of hash code-based Peer 2 Peer protocols is effective because all Peer 2 Peer programs that NGD 102 currently supports use extended HTTP for the download protocol. In the case of popular Fasttrack client Kazaa, a theoretical request structure is as follows:
1 GET /.hash=d0633flbfdd0fde48cf351ef8c541b67567426dd HTTP/1.1
2 Host: 123.52.193.31:1214
3 User-Agent: KazaaClient Jul 20 2003 23:25:14
4 X-Kazaa-Username: logn
5 X-Kazaa-Network: KaZaA
6 X-Kazaa-IP: 213.77.151.176:2647
7 X-Kazaa-SupernodeIP: 206.158.106.142:1715
8 Connection: close
9 X-Kazaa-XferId: 11312345
10 X-Kazaa-XferUid: ytCcDgo+3sTohN12+1Y2jYkCY6NwCA==

In the case of popular Gnutella client Morpheus, a theoretical request structure is as follows:
1 GET http://81.65.32.7:6346/uri-res/N2R?urn:sha1:F3HBAWBPQWOS5G5GBCDBPYDMG5NZIA2P HTTP/1.1
2 Host: 81.65.32.7:6346
3 User-Agent: Morpheus 3.3.0.24 (GnucDNA 0.9.2.6)
4 Listen-IP: 206.170.247.13:13484
5 Connection: Keep-Alive
6 Proxy-Connection: close
7 Range: bytes=104144-524287
8 X-Queue: 0.1
9 X-Gnutella-Content-URN: urn:sha1:F3HBAWBPQWOS5G5GBCDBPYDMG5NZIA2P

In both cases, a hash code is extracted as per the application-level's protocol and matched against Database 103. Currently, this hash code is embedded into Line 1 for both Kazaa and Morpheus, but the NGD 102 can extract it from other sections in the same manner.

If a protocol does not use hash codes, it is very difficult to download from two or more peers from the same time. For these protocols, the NGD 102 uses the near real-time information constantly being gathered by the CSF and sent to each NGD 102, and basis its blocking decision on the unique resource request structure the protocol uses. For instance, Fasttrack and Gnutella define an alternate download method that is also used as the primary download protocol for dozens of less popular Peer 2 Peer programs to interoperate. In this scenario, a user can generally only download any given resource from one single peer at a time. This alternate protocol does not include the hash code as part of the client request but rather appends a unique number to the beginning of the requested resource name.

The NGD 102 handles these protocols by relying on the CSF to constantly monitor the peers on the supported non-hash code Peer 2 Peer networks, download resources from the peers and match them against the CSF's data warehouse, and send one packet of information to update the Database 103 if the resource is considered illegal by the CSF. In the following scenario where the CSF is monitoring the Grokster Peer 2 Peer network, the CSF is constantly searching for the term “Michael Jackson Thriller”, downloading the resource from any peer which is hosting this file according to Grokster's search algorithm, and verifying it to be illegal against the CSF data warehouse. As an example, the CSF finds this resource on a Grokster peer whose IP address is 163.118.98.30 and is listening on port 3504, and updates the P2P-Alternate Database 103 table with the following information: 1) 163.118.98.30, 2) 3504, 3) 14160, 4) Michael Jackson—Thriller.mp3, 1. This information is found because the CSF uses Grokster itself to download the material and thus has access to its protocol. This example would use the following request structure:
1 GET /14160/Michael%20Jackson%20-%20Thriller.mp3 HTTP/1.1
2 Host: 163.118.98.30:3504
3 UserAgent: KazaaClient May 28 2002 14:48:42
4 X-Kazaa-Username: logn
5 X-Kazaa-Network: Grokster
6 X-Kazaa-IP: 127.0.0.1:0
7 X-Kazaa-SupernodeIP: 67.161.65.106:2167
8 Connection: close
9 X-Kazaa-XferId: 1610030

After being updated with this new resource's identifying information by the CSF, NGD 102 can extract the same information and end the transmission if a match against Database 103 is found.

### UDP

UDP is used to send individual packets from one machine to another. The NGD 102 routes UDP packets but may not filter them. It performs this functionality to comply with the SOCKS version 5 protocol. The NGD 102 must always support UDP since it may someday be used as a download protocol. Since UDP is a stateless protocol and there is no guarantee for the arrival or ordering of the packets, the NGD 102 will hold the packets in memory and interpret these packets by re-ordering them according to their application-level protocol. For instance, in a typical client/server communication where UDP is used, some packets may or may not arrive, and if they do arrive it is not understood implicitly by the IP-layer what order they should be processed. This must be done explicitly by the client and server. As an example, if the client is sending three UDP packets to a server and order and reliability is to be maintained, the client must specify the order in one or more bytes of the UDP packet. If the NGD 102 determines that the UDP packet is being sent by an application-level protocol that is must filter, then it finds the bytes specifying order, holds all three packets in memory, re-orders the bytes, and filters this in-memory data packet stream as described above. Thus, if the resource identifying information is anywhere in the three packets, or a combination of the three packets, the NGD 102 will be able to find the necessary metadata.

It should be noted that this functionality is not used by the NGD 102 in its preferred embodiment as all current NGD 102 supported application-level protocols use TCP. It is programmatically difficult to ensure reliable client server communication using UDP. Thus TCP has become the de facto standard for IP communication and is used by the vast majority of clients and servers. It is believed that UDP will someday be used to try and circumvent NGD 102.

### SMTP

SMTP is the Internet's primary mail protocol. A spammer (sender of junk email) generally makes direct connections to external SMTP servers using DNS Mail Exchange routing. This bypasses the ISP's internal SMTP server, and thus the user is free to mask their identity and hide their actions from the ISP.

When NGD 102 detects a TCP connection to an SMTP server, it can stop this connection. If an ISP chooses to use this functionality, it is required to set known SMTP servers which their users are allowed to use. All other SMTP server communication will be stopped.

### Instant Messaging (™)

Instant Messaging (™) programs use their own protocols. The Internet Engineering Task Force is currently standardizing one protocol for all programs to use.

Therefore, while there has been described what is presently considered to be the preferred embodiment, it will be understood by those skilled in the art that other modifications can be made within the spirit of the invention.

1. In an information handling system for identifying network resources comprising packets of data received from a network, a method comprising:
receiving a network resource comprising one or more packets, each packet comprising a header and data portion;
scanning the bytes of the one or more packets to determine the application-level protocol, and thus the application, the sender of the bytes is using.
parsing the bytes of the one or more packets according to the specific application-level protocol to extract identifying information relating to a specific resource requested;
comparing the extracted information to a list of identifying information stored in a real-time database; and
providing a message indicating that the extracted information matches at least one entry in the real-time database when the comparison is positive.

2. The method of claim 1, wherein the receiving step comprises receiving a plurality of packets according to the Transmission Control Protocol.

3. The method of claim 1, wherein the receiving step comprises receiving a plurality of packets according to the User Datagram Protocol.

4. The method of claim 1 wherein the one or more packets use the hypertext transfer protocol, the scanning step comprises extracting a destination domain name or IP address from a hypertext transfer protocol packet stream and the comparing step comprises comparing the address extracted with addresses stored in the database.

5. The method of claim 1 wherein the one or more packets follow the hypertext transfer protocol and the scanning step further comprises extracting the port, path, and name of the web resource from a hypertext transfer protocol packet stream.

6. The method of claim 1 wherein, the scanning step comprises extracting a hash code from a received peer to peer protocol packet stream.

7. The method of claim 1 wherein, the scanning step comprises extracting additional information comprising port, identity key, and filename from a peer to peer protocol packet stream.

8. The method of claim 1 wherein, the scanning step comprises extracting a user agent name, additional HTTP extension headers, or other information needed to identify a specific program from a peer to peer protocol packet stream.

9. The method of claim 1 wherein, the scanning step comprises extracting a filename and path received from a file transfer protocol packet stream.

10. The method of claim 1 wherein the scanning step further comprises detecting a transmission control protocol connection to an external simple mail transfer protocol server, and limiting access to the external simple mail transfer protocol server.

11. The method of claim 1 further comprising logging all instant message communication.

12. The method of claim 1 further comprising providing a message announcing a match upon identifying the match.

13. The method of claim 1 wherein, the comparing step, upon identifying a match, further comprises blocking the user from accessing the resource corresponding to the matching identifying information.

14. The method of claim 1 wherein the identifying information corresponds to illegal copies of files.

15. The method of claim 1 wherein the identifying information corresponds to prohibited resources.

16. The method of claim 1 wherein the scanning step comprises extracting an IP address from at least one packet and the comparing step comprises comparing the IP address with a set of IP addresses stored in the database.

17. The method of claim 1 wherein the identifying information comprises a hash code.

18. The method of claim 1 wherein the identifying information corresponds to suspicious files and wherein a client requesting a file whose identifying information matches an identifying information stored in the database is presented a warning.

19. The method of claim 1 wherein, the comparing step upon identifying a match further comprises limiting access by clients to external simple mail transfer protocol servers.

20. The method of claim 1 further comprising using identifying information found by a central server farm comprising specialized search engines and a human staff to populate the database.

20. The method of claim 13 wherein the blocking step is accomplished by ending client/server communication for a request that contains the matching identifying information.

21. The method of claim 13 wherein the blocking step is accomplished by ending client/server communication for a response that contains the matching identifying information.

22. The method of claim 1 wherein the receiving step comprises receiving a plurality of packets according to the Simple Mail Transfer Protocol.

23. The method of claim 1, wherein the scanning step further evaluates additional headers and the data portion of the hypertext transfer protocol, such as web forms on an html page, based on the address.

24. A system comprising:
a network interface for receiving data packets from a network;
a processor for extracting identifying information from the data packets and for comparing the extracted identifying information with the identified information stored in a database; and
an output for providing a message stating when a match has been found.

25. The system of claim 24 further comprising a memory for storing the identified information to be compared with the information extracted from the received packets.

26. A local area network comprising a network gateway device comprising: a network interface for receiving data packets; a processor for extracting identifying information and for comparing the extracted identifying information with the identifying information stored in a database; and an output for providing a message stating that a match has been found when the comparison is positive.

27. The local area network of claim 26 further comprising the database.

28. The local area network of claim 26 further comprising a router disposed between the network gateway device and a firewall connecting the local area network to a wide area network.

29. The local area network of claim 26 further comprising a load balancer disposed between the router and a firewall.

30. The local area network of claim 26 further comprising a network gateway device disposed between a router and a load balancer.

31. The local area network of claim 26 further comprising a load balancer disposed between the network gateway device and a firewall connecting the local area network to a wide area network.

32. The local area network of claim 26 further comprising a router containing the network gateway device.

33. The local area network of claim 26 further comprising a firewall disposed between the router containing the network gateway device and the wide area network.

34. The local area network of claim 26 further comprising a firewall containing the network gateway device.

35. The local area network of claim 26 further comprising the firewall containing the network gateway device disposed between a router and the wide area network.
